(19) United States
(12) Patent Application Publication
(10) Pub. No.: US 2009/0274950 A1
(43) Pub. Date: Nov. 5, 2009

(54) ELECTROCHEMICAL CELL, AND SYSTEM COMPRISING AT LEAST ONE ELECTROCHEMICAL CELL AND A HOUSING

(76) Inventors: Jochen Fassnacht, Calw (DE); Richard Aumayer, Dielehodzen (DE)

Correspondence Address: MICHAEL J. STRIKER, 103 EAST NECK ROAD, HUNTINGTON, NY, 11743, US

(21) Appl. No.: 12/296,555

(22) PCT Filed: Dec. 12, 2007
(86) PCT No.: PCT/EP07/63797

§ 371 Date: Oct. 9, 2008

(30) Foreign Application Priority Data
Jan. 30, 2007 (DE) 102007004568.0

(51) Int. Cl. H01M 2/36

(52) U.S. Cl. 429/72

(57) ABSTRACT

The invention is based on an electrochemical cell, having an electrode pack (12) and an outer skin (16) surrounding the electrode pack (12), in particular a laminated electrochemical cell.

It is proposed that a connection element (30) for an air vent (40) is provided.

### PRIOR ART

The invention is based on an electrochemical cell and a system comprising at least one electrochemical cell and a housing, as generically defined by the preambles to the independent claims.

In practically all electrochemical cells, the capability of carrying away fogs, gases, and liquids is provided for, since the individual cells, depending on the electrochemical system, either give off gases constantly, or in extreme cases, such as overcharging or misuse, give off gases and liquids that are a threat to health.

In sophisticated traction systems such as hybrid motor vehicles, very powerful electric reservoirs are needed. Nickel-metal hydride reservoirs are known for this purpose, which are combined for instance in many modules each with a plurality of individual cells as a storage unit or in the form of powerful alternative lithium-ion batteries. In addition to cylindrical cells, so-called laminated cells, also called “coffee bag” cells, are known to be economical and powerful alternatives, which because of their large surface area make it possible for the heat of reaction to be dissipated especially effectively.

In European Patent Disclosure EP 1 577 973 A1, such “coffee bag” cells are described as rectangular, very flat cells. In such cells, the electrode packs are located in a lined metal foil that conforms to the electrode pack. The cells are correspondingly soft. They are typically combined into a plurality of modules and connected electrically parallel and/or in series. Rated breaking points in the outer skin, for instance, are provided as a safety device.

### DISCLOSURE OF THE INVENTION

The invention is based on an electrochemical cell, in particular a laminated electrochemical cell, having an electrode pack and an outer skin that surrounds the electrode pack.

It is proposed that a connection element for an air vent be provided. Advantageously, for instance upon response of a safety valve of the cell, substances escaping from laminated cells can be carried away in an orderly manner. The escaping medium can be intentionally conducted into a region where there is as much as possible no threat to humans. Penetration of gases, fogs and/or liquids into a passenger compartment (in use particularly in hybrid vehicles or electric vehicles) can be prevented, as can an uncontrolled escape to outside. Optionally, the escaping medium can be caught in a separate collection container, which can also be filled with a suitable absorber.

In an advantageous feature, in the manufacture of the cell, the connection element can be integrated with the outer skin and directly laminated with it in a sealing operation for closing the cell. This connection element can be embodied for instance as a small vent pipe and can optionally include a safety valve.

A feature in which the connection element has a receiving element for captive mounting of a tube or pipe is especially expedient. Hence the connection element can have a olive-shaped button for a tube, onto which button a tube is slipped. A detent element which prevents the tube from slipping off can equally well be provided.

The invention, in a further aspect, takes as its point of departure a system comprising at least one electrochemical cell and a housing, in which the cell has an electrode pack and an outer skin surrounding the electrode pack.

It is proposed that a connection element for an air vent is provided. The connection element may, as described above, be located on the cell itself and/or on the housing as well.

In an advantageous feature, the connection element can be connected to a safety valve that is integrated with the outer skin. It can thus be assured that upon response of the safety valve, escaping media can be caught by the connection element and purposefully carried away to regions provided for the purpose.

The connection element can preferably be is located sealingly above the safety valve, and the safety valve can empty into a gas chamber inside the connection element.

Assembly can be accomplished especially simply if the housing has a recess for the connection element. This is especially favorable whenever the connection element is slipped onto the outer skin of the cell via the safety valve. Alternatively, the connection element can be integrated with the housing. In that case, the connection element upon assembly should rest as tightly as possible against the cell surface.

The cells can be combined in the form of a stack. Depending on the desired voltage or electrical power, one or more such stacks can be combined in a battery pack. An installed position of one or more stacks can be intrinsically arbitrary in a corresponding battery pack; that is, it may be vertical, horizontal, transverse, or the like. One skilled in the art will select the appropriate installation position in each case to suit given peripheral conditions.

### BRIEF DESCRIPTION OF THE DRAWINGS

### Drawings

Further advantages will become apparent from the ensuing description of the drawings. In the drawings, exemplary embodiments of the invention are shown. One skilled in the art will expediently consider the characteristics, disclosed in combination in the drawings, specification and claims individually as well and put them together to make appropriate further combinations.

Shown are:

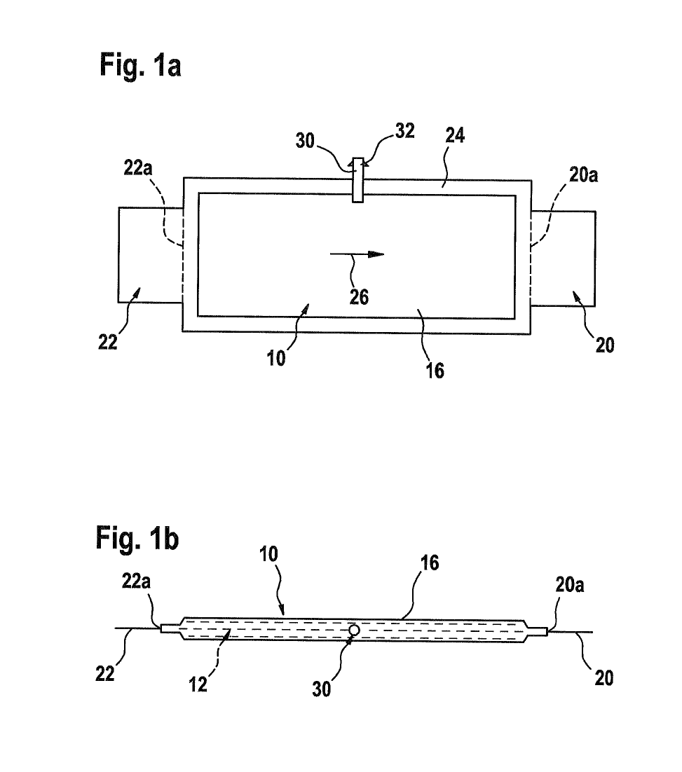

FIGS. 1a, b, a side view of a preferred laminated cell with an integrated connection element (FIG. 1a) and a top view on the preferred cell (FIG. 1b);

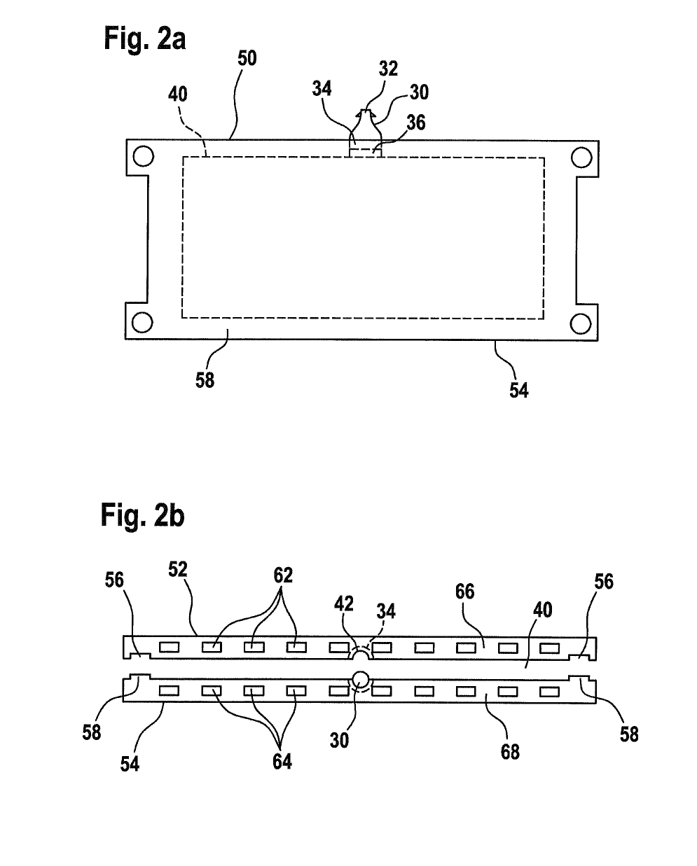

FIGS. 2a, b, a side view of a preferred housing for a preferred cell in FIG. 1 (FIG. 2a), and a top view on the preferred housing (FIG. 2b);

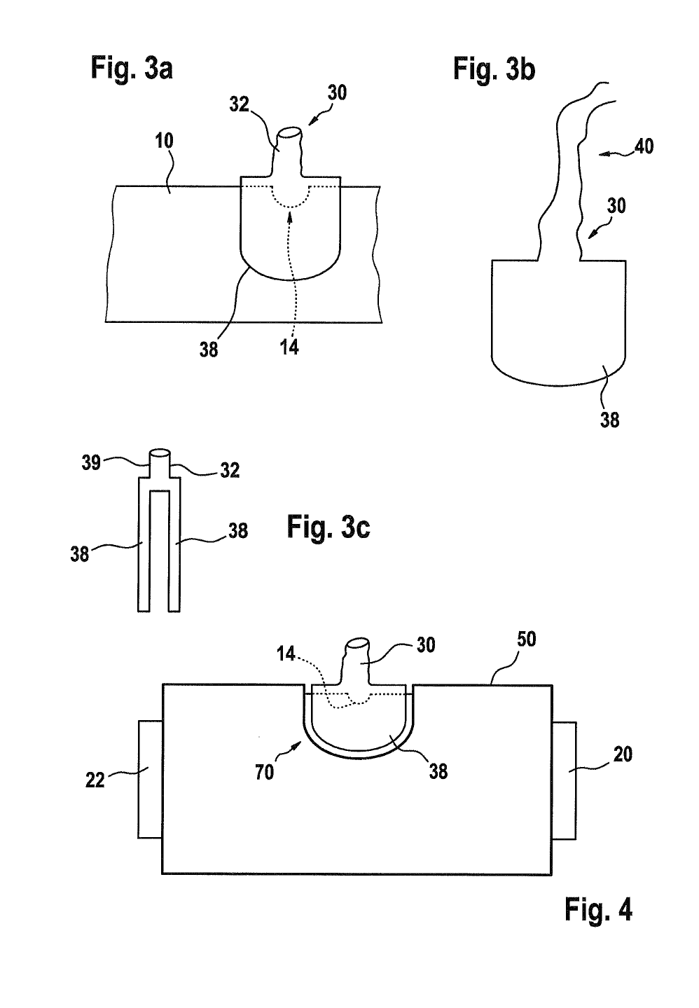

FIG. 3, in a side view, a detail of a preferred connection element (FIG. 3a); the connection element with the attached tube (FIG. 3b); and a side view of a short side of the connection element (FIG. 3c); and

FIG. 4, a side view of a preferred housing with a preferred connection element as in FIG. 3.

### EMBODIMENTS OF THE INVENTION

In the drawings, identical or similar components are identified by the same reference numerals.

FIGS. 1a and 1b, in a side view (FIG. 1a) and a top view (FIG. 1b), show a first preferred exemplary embodiment in terms of a laminated electrochemical cell 10 with an electrode pack 12 and an outer skin 16 surrounding the electrode pack 12. The cell 10 is embodied as rectangular and flat and has a longitudinal direction 26. At exit points 20a and 22a from the cell 10, current diverters 20 and 22 escape laterally, in the longitudinal direction 26, from the outer skin 16.

A cell edge 24 is sealed off all the way around, in particular welded, and is interrupted at one point by a connection element 30, which is jointly laminated in place in the closure of the outer skin 16. The connection element 30 is embodied as a small vent tube and, as indicated in the drawing, on a stub 32, it has a detent lug or an olive-shaped button for a tube, to enable slipping a tube on in captive fashion. The tube, not shown, carries media escaping from the cell 10 into a region provided for them.

In FIGS. 2a and 2b, an exemplary embodiment of a preferred system is shown, in which an electrochemical cell 10 is located in a housing 50 that comprises two housing parts 52 and 54. The cell 10 is received in a receptacle 40 and can be clamped in place at its edge between the housing parts 52, 54. To that end, the edge of the cell 10 can be press-fitted into a groove 56 by means of a toroidal bead 58. In surrounding edges 66 and 68 of its housing parts 52 and 54, the housing 50 has ventilation slots 62 and 64, to enable cooling the cell 10.

A connection element 30 is integrated with the housing 50 here and includes a gas chamber 34 that is located sealingly on the cell 10, preferably in a region of a possible rated breaking point, not shown, or of a safety valve of the cell 10. The connection element 30 is fixed to the one housing part 54, while a suitable recess 42 is provided on the other housing part 52. A tube or pipe can also be slipped in captive fashion onto this connection element 30, at a stub 32.

In FIGS. 3a, 3b and 3c, detail views are shown of a further preferred connection element 30, which can be slipped onto a laminated cell 10. The connection element 30 is preferably slipped over an existing rated breaking point 14 of the cell 10. A stub 32 of the connection element 30, onto which stub a tube 40 can be slipped (FIG. 3b) merges with a pair of clamps that have two clamp faces 38, between which the cell 10 is located (FIG. 3c).

FIG. 4 shows a feature of the embodiment in FIG. 3 in which the cell 10 is located in a housing 50 embodied as a frame. The housing 50 has a recess 70, which is adapted to the connection element 30 and leaves its clamp faces 38 free.

It is understood that the cells 10 described in the various exemplary embodiments, with and without a housing 50, can also be combined into modules having a plurality of cells 10. The connection elements 30 of each cell 10 can then be connected especially advantageously to a common diversion line of the module.

1. An electrochemical cell, having an electrode pack (12) and an outer skin (16) surrounding the electrode pack (12), in particular a laminated electrochemical cell, characterized by a connection element (30) for an air vent (40).

2. The cell as defined by claim 1, characterized in that the connection element (30) is integrated with the outer skin (16).

3. The cell as defined by claim 1, characterized in that the connection element (30) has a safety valve.

4. The cell as defined by claim 1, characterized in that the connection element (30) has a receiving element (32) for captive slipping on of a tube (70) or pipe.

5. A system comprising at least one electrochemical cell (10) and a housing (50), in which the cell (10) has an electrode pack (12) and an outer skin (16) surrounding the electrode pack (12), characterized in that a connection element (30) for an air vent (40) is provided.

6. The system as defined by claim 5, characterized in that the connection element (30) is connected to a safety valve (14) that is integrated with the outer skin (16).

7. The system as defined by claim 6, characterized in that the connection element (30) is located sealingly above the safety valve (14), and the safety valve (14) is capable of emptying into a gas chamber (34) inside the connection element (30).

8. The system as defined by claim 5, characterized in that the housing (50) has a recess (42, 70) for the connection element (30).

9. The system as defined by claim 5, characterized in that the connection element (30) is slipped onto the outer skin (16) of the cell (10) via the safety valve (14).

10. The system as defined by claim 5, characterized in that the connection element (30) is integrated with the housing (50).
